(19) United States
(12) Patent Application Publication
(10) Pub. No.: US 2021/0362257 A1
(43) Pub. Date: Nov. 25, 2021

(54) PIPE THREADING SYSTEMS

(71) Applicant: Daniel Mitchell, Lyons, OR (US)

(72) Inventor: Daniel Mitchell, Lyons, OR (US)

(21) Appl. No.: 17/326,150

(22) Filed: May 20, 2021

Related U.S. Application Data
(60) Provisional application No. 63/027,805, filed on May 20, 2020.

(51) Int. Cl. B23G 1/24

(52) U.S. Cl. CPC B23G 1/24; B23G 2240/12

(57) ABSTRACT

A method, system, apparatus, and/or device for threading a pipe may include: a housing including a cavity to store a pipe threading machine. The housing includes a door to open to provide access to the cavity and an opening along a side wall of the housing to receive an end of a pipe. The pipe threading machine located within the cavity. The pipe threading machine is to cut the pipe, ream the pipe, and thread the pipe using one or more attachments. An oiler is configured to apply oil to the pipe and the one or more attachments as the pipe threading machine cuts the pipe, reams the pipe, and threads the pipe. An oil catching system is located within the cavity below the oiler and the pipe threading machine to catch oil dripping or spraying from the pipe threading machine, the oiler, or the pipe.

### REFERENCE TO RELATED APPLICATIONS

The present application claims priority to U.S. Non-Provisional Patent Application No. 63/027,805 entitled “PIPE THREADING SYSTEMS”, filed on 20 May 2020. The entire contents of the above-listed application are hereby incorporated by reference for all purposes.

### BACKGROUND

Certain machine tools, such as pipe threaders, are often used in a field setting. The tools are portable and have their own sturdy stands. A pipe threader uses interchangeable tooling heads for threading, cutting, and reaming pipe.

### BRIEF DESCRIPTION OF THE DRAWINGS

The present description will be understood more fully from the detailed description given below and from the accompanying drawings of various embodiments of the present embodiment, which is not to be taken to limit the present embodiment to the specific embodiments but are for explanation and understanding.

FIG. 1 illustrates a pipe threading system, according to an embodiment.

FIG. 2 illustrates a side wall of the pipe threading system that includes the opening, according to an embodiment.

FIG. 3A illustrates the shelf within the housing, according to an embodiment.

FIG. 3B illustrates a top view of the shelf in FIG. 3A, according to an embodiment.

FIG. 4 illustrates the shelf within the housing, according to an embodiment.

FIG. 5 illustrates the shelf within the housing, according to an embodiment.

FIG. 6 illustrates the housing with brackets, according to an embodiment.

FIG. 7 illustrates the oil catcher in FIG. 1, according to an embodiment.

FIG. 8 illustrates a pan or container beneath the funnel of the oil catcher in FIG. 1, according to an embodiment.

FIG. 9 illustrates an opening at a left side wall of the housing of the pipe threading system, according to an embodiment.

FIG. 10 illustrates an opening at a left side wall of the housing of the pipe threading system, according to an embodiment.

FIG. 11 illustrates a door that may be configured to cover the opening or be opened to allow objects to be received through openings, according to an embodiment

FIG. 12 illustrates slide rails attached to the housing in FIG. 1, according to an embodiment.

FIG. 13A illustrates a sliding door bearing wheel shaft, according to an embodiment.

FIG. 13B illustrates a disassembled view of the sliding door bearing wheel shaft in FIG. 13A, according to an embodiment.

### DETAILED DESCRIPTION

The disclosed pipe threading systems will become better understood through a review of the following detailed description in conjunction with the figures. The detailed description and figures provide merely examples of the various embodiments described herein. Those skilled in the art will understand that the disclosed examples may be varied, modified, and altered and not depart from the scope of the embodiments described herein. Many variations are contemplated for different applications and design considerations; however, for the sake of brevity, the contemplated variations may not be individually described in the following detailed description.

Throughout the following detailed description, examples of various pipe threading systems are provided. Related features in the examples may be identical, similar, or dissimilar in different examples. For the sake of brevity, related features will not be redundantly explained in multiple examples. Instead, the use of related feature names will cue the reader that the feature with a related feature name may be similar to the related feature in an example explained previously. Features specific to a given example will be described in that particular example. The reader is to understand that a given feature need not be the same or similar to the specific portrayal of a related feature in any given figure or example.

Portable pipe threading machines continuously apply oil to a pipe cutting attachment, a reamer, and/or a cutting die during use. Conventionally, pipe threading machines cut a pipe, ream the pipe, and thread the pipe to produce a threaded pipe of a desired length. A cutting attachment may be attached to the pipe threading machine and the cutting attachment may be used to cut the pipe to a desire length. A reamer may be attached to the pipe threading machine and used to ream an end of the pipe to remove burrs and ensure a consistent opening at the end of the pipe. A threading die may be attached to the pipe threading machine, where the pipe is run through the threading die to thread the end of the pipe.

As a machine operator uses the various attachments of the pipe threading machine to cut, ream, and thread a pipe, the machine operator may use an oiler to apply thread cutting oil to the pipe during each operation. Conventionally, the oiler includes a tub with a colander or basket. The oiler may be placed beneath the work area of the pipe threading machine to catch oil drippings during the cutting, reaming, and threading of the pipe. Conventional oilers are insufficient for capturing all oil and metal shavings escaping from the portable threading machines during the cutting, reaming, and threading of the pipe. The escaping oil and metal shaving may leave an oily mess on the floor or ground around the oiler and pipe threading machine with sharp metal shavings from the threaded pipe and cutting oil. The oily mess may stain the ground or floor where the pipe threading machine is operated, which requires an expensive and time-consuming cleaning process to remove the metal shavings and cutting oil and often the cutting oil leaves being an oil stain that may not be entirely removed during the cleaning process. Additionally, the conventional pipe threading machine must be disassembled, moved to a job site, and reassembled, which is further time consuming and decreases an efficiency of a user.

Implementations of the disclosure address the above-mentioned deficiencies and other deficiencies by providing methods, systems, devices, or apparatus to thread a pipe. The pipe threading system may include a portable job box with a transportable housing with a cavity to house a pipe threading machine, an oiler, and an oil catcher. An advantage of the pipe threading system may be to provide a user with a transportable pipe threading system that may be moved to different locations without having to disassemble and reassemble the pipe threading system. Another advantage of the pipe threading system may be to catch the oil used during the threading process with the oil catch to reduce or eliminate the oily mess created during the threading process.

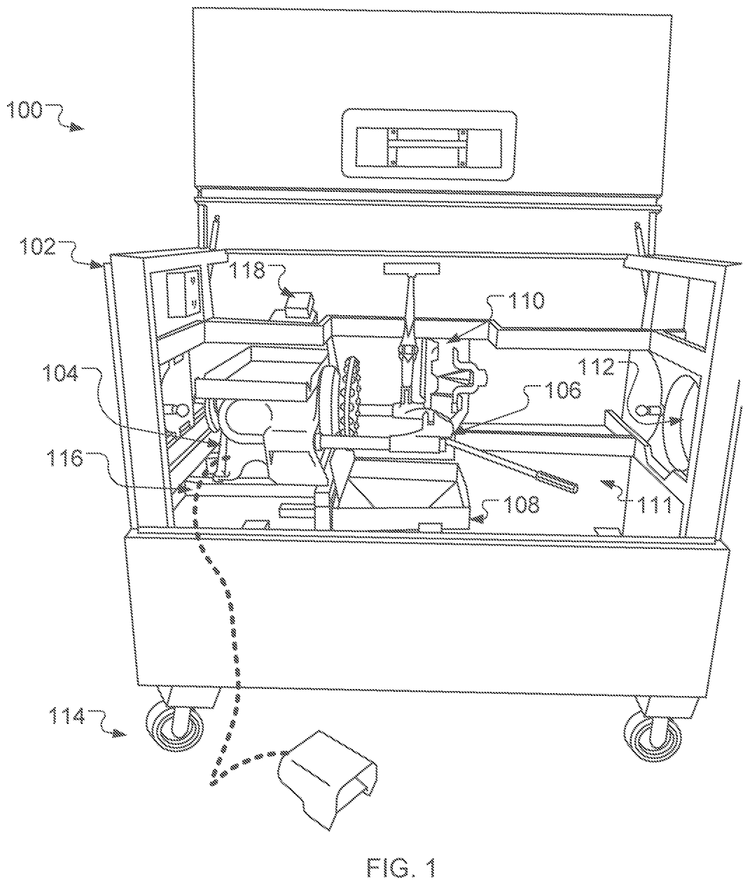

FIG. 1 illustrates a pipe threading system 100, according to an embodiment. The pipe threading system 100 may include a transportable housing 102, a pipe threading machine 104, an oiler 106, and an oil catcher 108, according to an embodiment. In one embodiment, the transportable housing 102 may include a housing with a cavity 111 to store the pipe threading machine 104, an oiler 106, and an oil catcher 108. The transportable housing 102 may include a retractable or folding door to provide a user access to the pipe threading machine 104, an oiler 106, and an oil catcher 108 stored within the cavity 111. In one example, the retractable or folding door may fold upward or downward to open at least a portion of a side wall and/or top wall of the housing 102. The housing 102 may include wheels or rollers 114 to allow a user to transport the pipe threading system 100 by pushing and/or pulling the pipe threading system 100 between locations. In one embodiment, the housing 102 may include an opening 112 to receive an end of a pipe. The opening 112 may be located at a side wall of the housing 102 and be sized and shaped to receive an end of a pipe to be threaded.

In one embodiment, the cavity 111 may include one or more shelves or stands to hold the pipe threading machine 104, the oiler 106, the oil catcher 108, and or other objects. For example, the cavity 111 may include a first shelve or stand 116 to support and hold the pipe threading machine 104. The pipe threading machine 104 may include attachments 110, such as a pipe cutting attachment, a reamer attachment, and/or a threader attachment. When a pipe has been inserted into the opening 112, the pipe threading machine 104 may engage the end of the pipe to secure the pipe in place. A user may then use one or more of the attachments 110 to thread the pipe. For example, the user may use the pipe cutting attachment to cut the pipe to a desired length. The user may then use the reamer attachment to remove burrs and ensure a consistent opening at the end of the pipe. The user may then use the threading attachment to thread the end of the pipe.

In one embodiment, the oiler 106 may be attached to the pipe threading machine 104. In another embodiment, the oiler 106 may be attached to the housing 102 and may be located approximate or near the pipe threading machine 104. The oiler 106 may be configured to provide oil onto the pipe and/or the attachments 110 as the user uses the attachments 110 to cut, ream, and/or thread the pipe. In one example, the oiler 106 may be connected to a pan or container of oil and may pump the oil from the pan or container and spray or drip the oil onto the pipe and/or the attachments 110. The oil may be used as lubrication to as the attachments 110 are used to thread the pipe to reduce the wear on the attachments 110 and reduce scoring or marking the pipe during threading.

The oil catcher 108 may be located within the cavity 111 of the housing and may be configured to catch the oil from the oiler 106, the pipe, and/or the attachments 110. For example, the oil catcher 108 may include a funnel that is located below the oiler 106. The funnel may receive oil that is sprayed or dripped by the oiler 106 and/or oil that drips from the attachments 110 and/or the pipe. The funnel may then direct the oil to a pan or container located below the funnel. In one embodiment, the pan or container may be the same pan or container used by the oiler 106, where the oil caught by the oil catcher 108 is recycled. In another embodiment, the pan or container of the oil catcher 108 may be a separate pan or container that may be removed and emptied or replaced when the pan or container becomes full. The oil catcher 108 may be configured so that the oil is contained within the housing 102 such that the oil does not escape the housing and does not stain or create an oily mess on the floor or ground where the pipe threading system 100 is located.

In another embodiment, the housing 102 may include shelves 116 that may be configured to hold tools and/or parts. For example, the housing may include a shelf 118 with a power supply unit that a user of the pipe threading system 100 may charge tools 118.

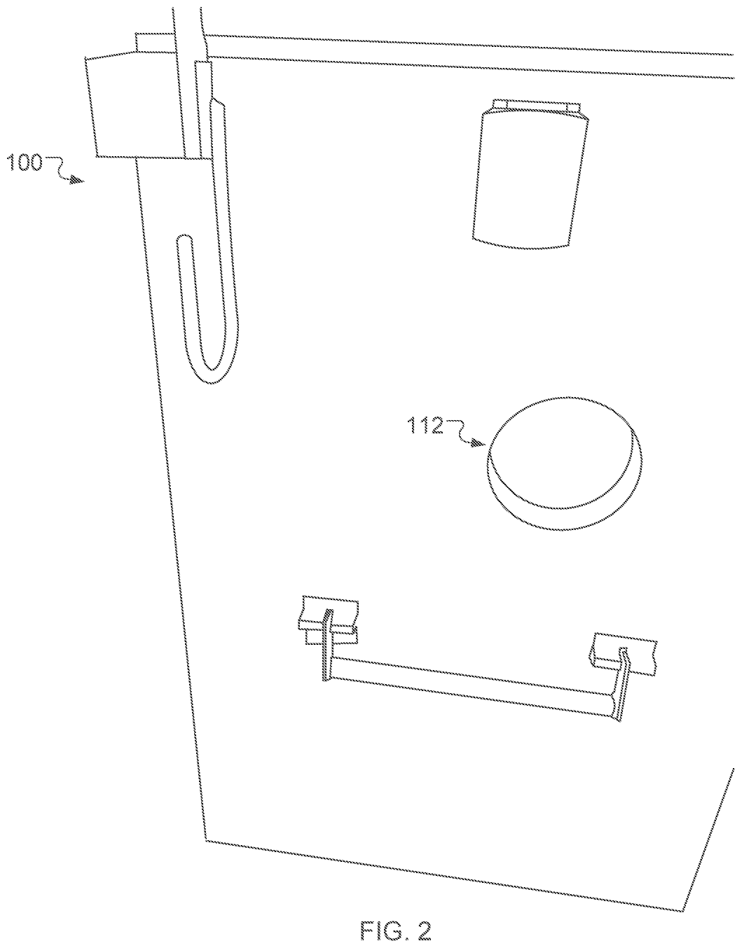

FIG. 2 illustrates a side wall of the pipe threading system 100 that includes the opening 112, according to an embodiment. Some of the features in FIG. 2 are the same or similar to some of the features in FIG. 1 as noted by same reference numbers, unless expressly described otherwise. In one embodiment, the opening 112 may be a hole in the side wall of the pipe threading system 100. In another embodiment, the opening 112 may include a door that may be opened to receive the pipe and closed when a pipe is not inserted and/or when the pipe threading system 100 is being transported.

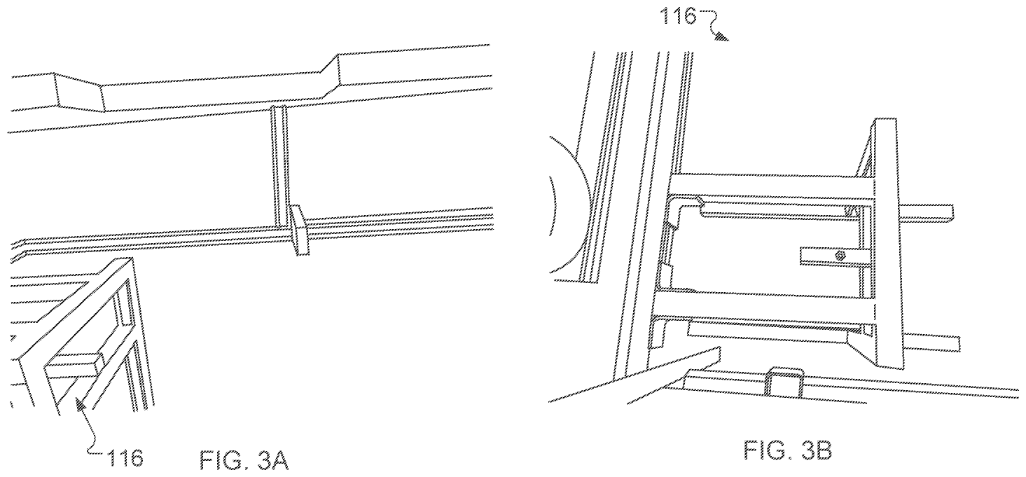

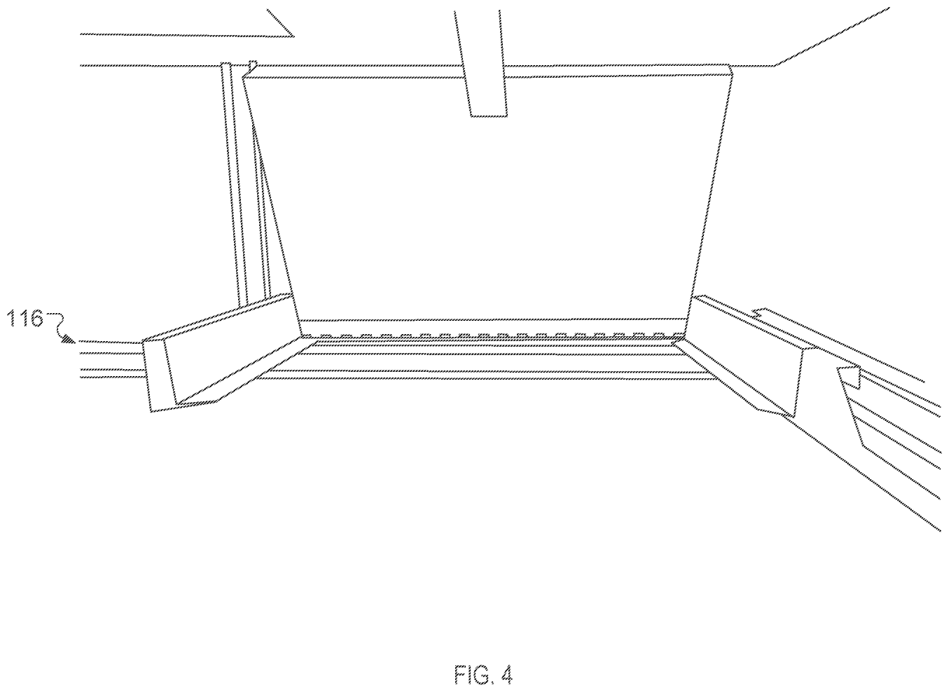

FIG. 3A illustrates the shelf 116 within the housing 102, according to an embodiment. Some of the features in FIG. 3A are the same or similar to some of the features in FIGS. 1-2 as noted by same reference numbers, unless expressly described otherwise. As discussed above, the shelf 116 may be configured to hold tools, parts, and/or the pipe threading machine 104. In another embodiment, the shelf 116 may be a unistrut structure with stiffener(s) to support the shelf. FIG. 3B illustrates a top view of the shelf 116 in FIG. 3A, according to an embodiment.

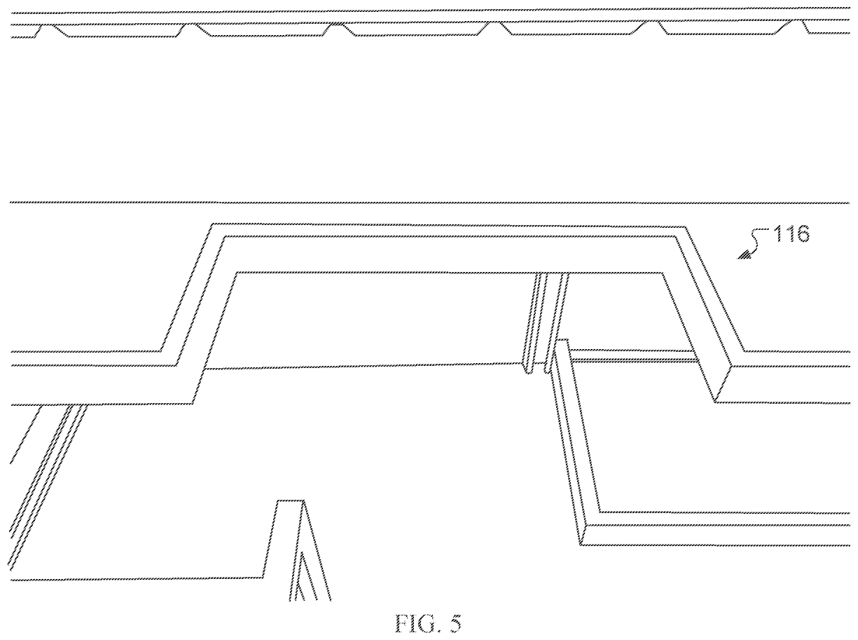

FIG. 4 illustrates the shelf 116 within the housing 102, according to an embodiment. Some of the features in FIG. 4 are the same or similar to some of the features in FIGS. 1-3B as noted by same reference numbers, unless expressly described otherwise. As discussed above, the shelf 116 may be configured to hold tools, parts, and/or the pipe threading machine 104. In another embodiment, the shelf 116 may be configure to rotate on hinge or about an axis to flip up or down to provide a shelf when a user desires to use it and to be folded toward the housing 102 to provide additional space in the cavity 111 of the housing 102 when the shelf is not in use.

FIG. 5 illustrates the shelf 116 within the housing 102, according to an embodiment. Some of the features in FIG. 5 are the same or similar to some of the features in FIGS. 1-4 as noted by same reference numbers, unless expressly described otherwise. As discussed above, the shelf 116 may be configured to hold tools, parts, and/or the pipe threading machine 104. In another embodiment, at least a portion of the shelf 116 may be notched or recessed to conform around part or pieces of the pipe threading system 100, such as the pipe threading machine 104 in FIG. 1

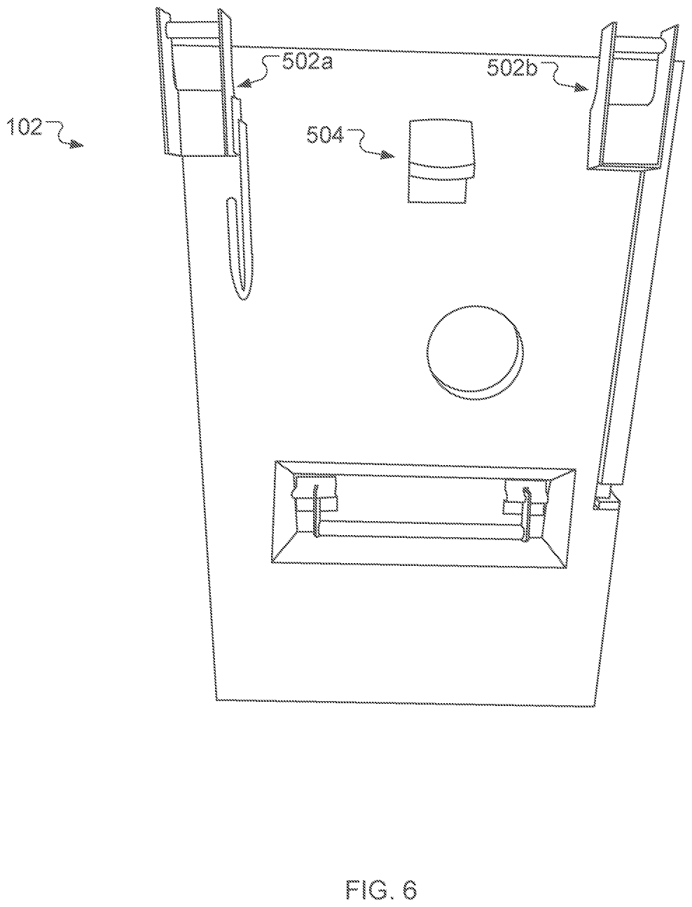

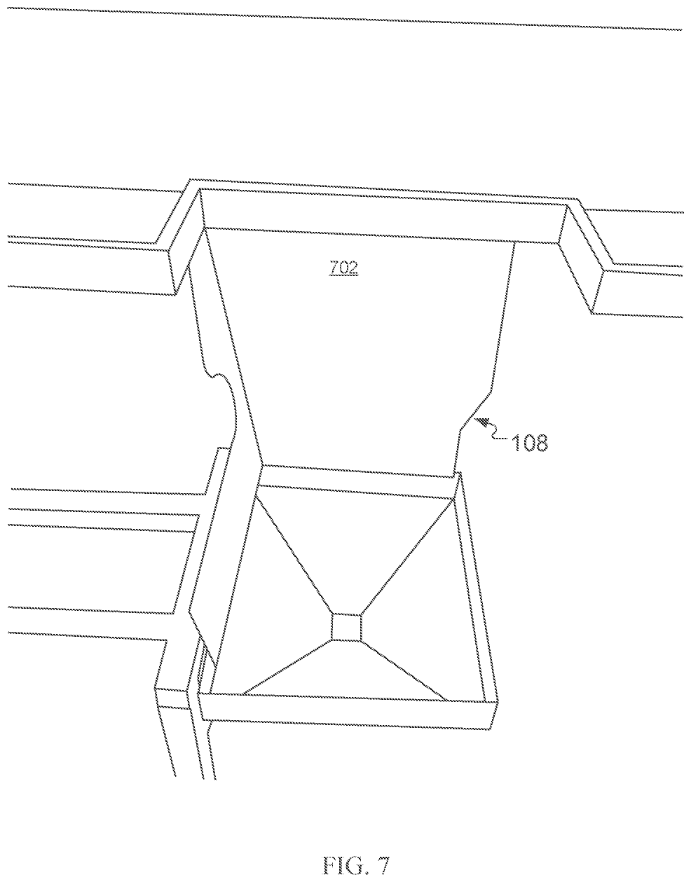

FIG. 6 illustrates the housing 102 with brackets 502a and 502b, according to an embodiment. Some of the features in FIG. 5 are the same or similar to some of the features in FIGS. 1-4 as noted by same reference numbers, unless expressly described otherwise. In one embodiment, a side of the housing 102 may include brackets 502a and 502b to lift and/or transport the pipe threading system 100 using a crane or a lift. The housing 102 may also include a power connector to connect the pipe threading system 100 with a power source to provide power to power outlets at the shelves, the pipe threading machine 104, and/or the oiler 106 in FIG. 1.

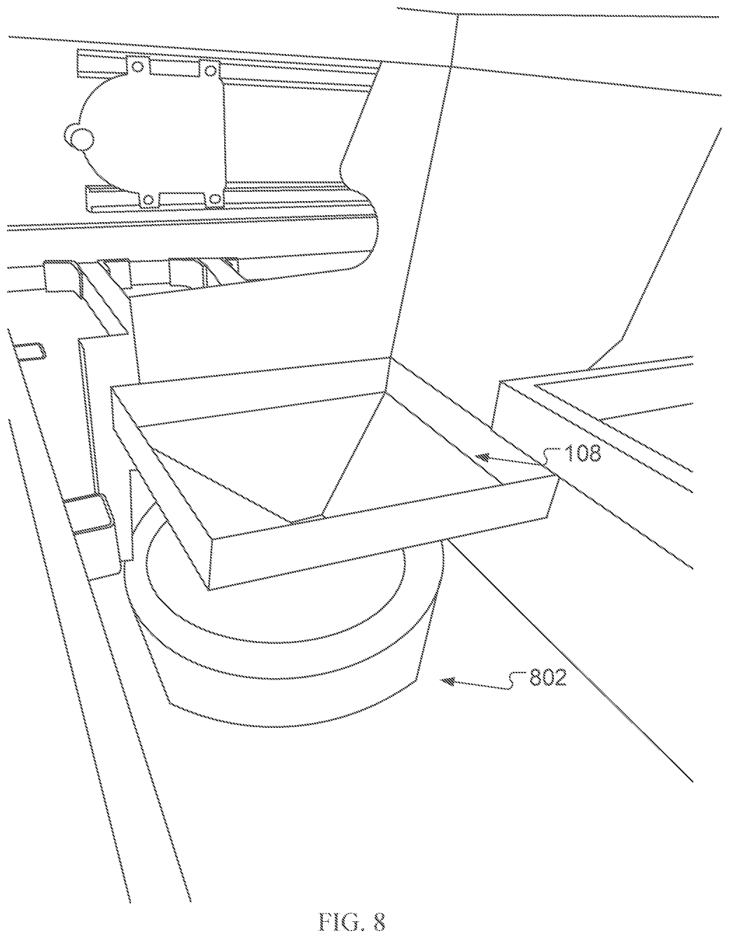

FIG. 7 illustrates the oil catcher 108 in FIG. 1, according to an embodiment. Some of the features in FIG. 7 are the same or similar to some of the features in FIGS. 1-6 as noted by same reference numbers, unless expressly described otherwise. As discussed above, the oil catcher 108 may be configured to catch or receive oil from the oiler 106, the pipe, and/or the attachments 110 in FIG. 1. In one embodiment, the oil catcher 108 may include a funnel to direct the oil from the oiler 106, the pipe, and/or the attachments 110. In another embodiment, the oil catcher 108 may include a splash guard or shield 702 that may extend upward from the funnel. The splash guard or shield 702 may prevent oil from splashing off the oiler 106, the pipe, and/or the attachments 110 into the cavity 111 of the housing 102 and may direct the splashed oil to the funnel.

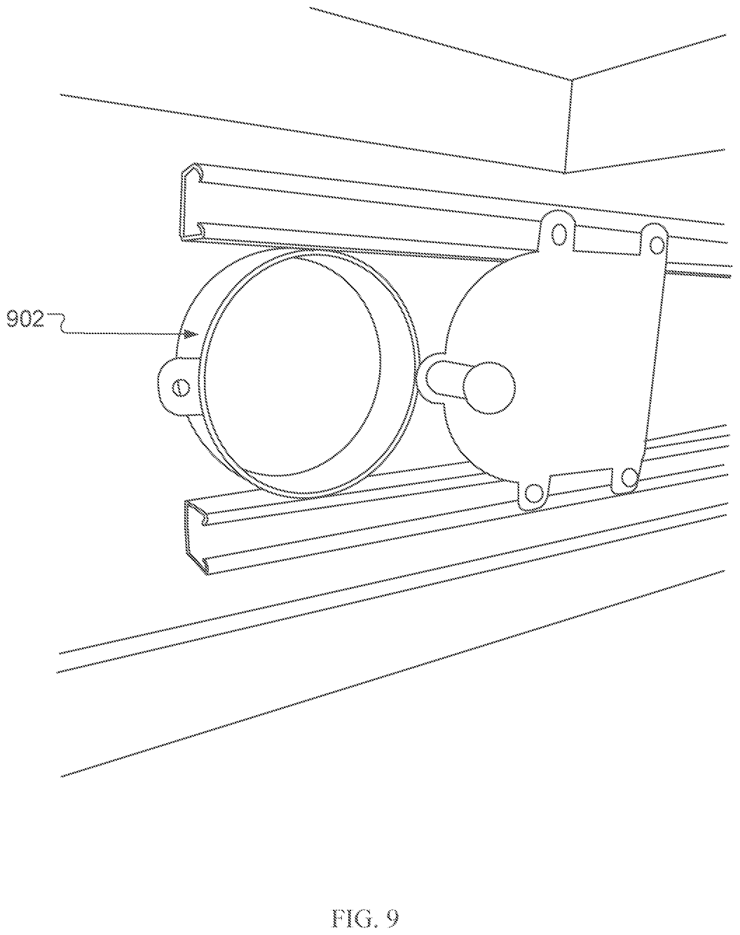

FIG. 8 illustrates a pan or container beneath the funnel of the oil catcher 108 in FIG. 1, according to an embodiment. Some of the features in FIG. 8 are the same or similar to some of the features in FIGS. 1-7 as noted by same reference numbers, unless expressly described otherwise. As discussed above, the oil catcher 108 may be configured to catch or receive oil from the oiler 106, the pipe, and/or the attachments 110 in FIG. 1. In one embodiment, the oil catcher 108 may include a funnel to direct the oil from the oiler 106, the pipe, and/or the attachments 110 into a pan or container 802 located beneath the funnel and within the cavity 111 of the housing 102 in FIG. 1.

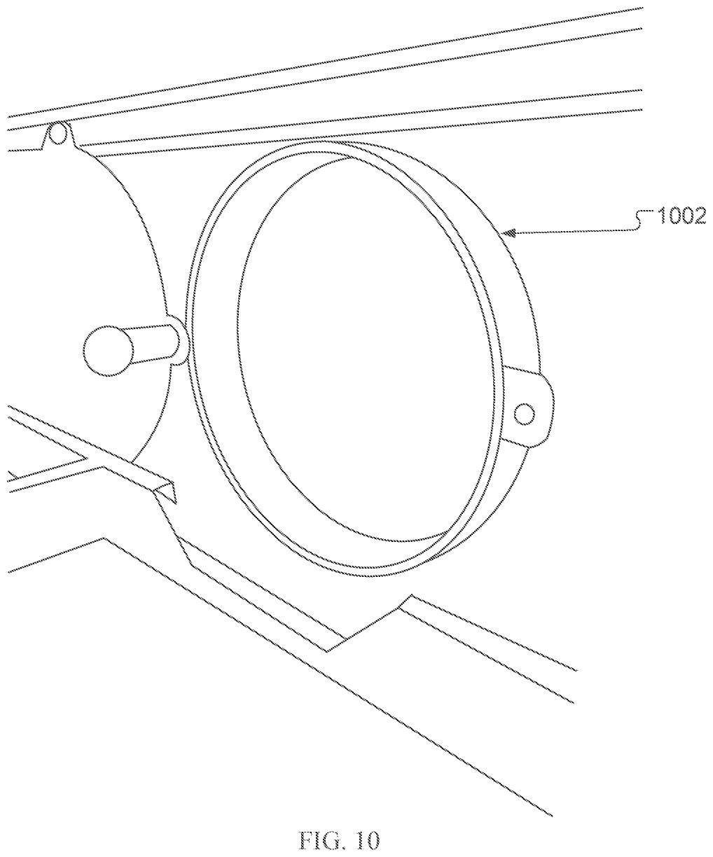

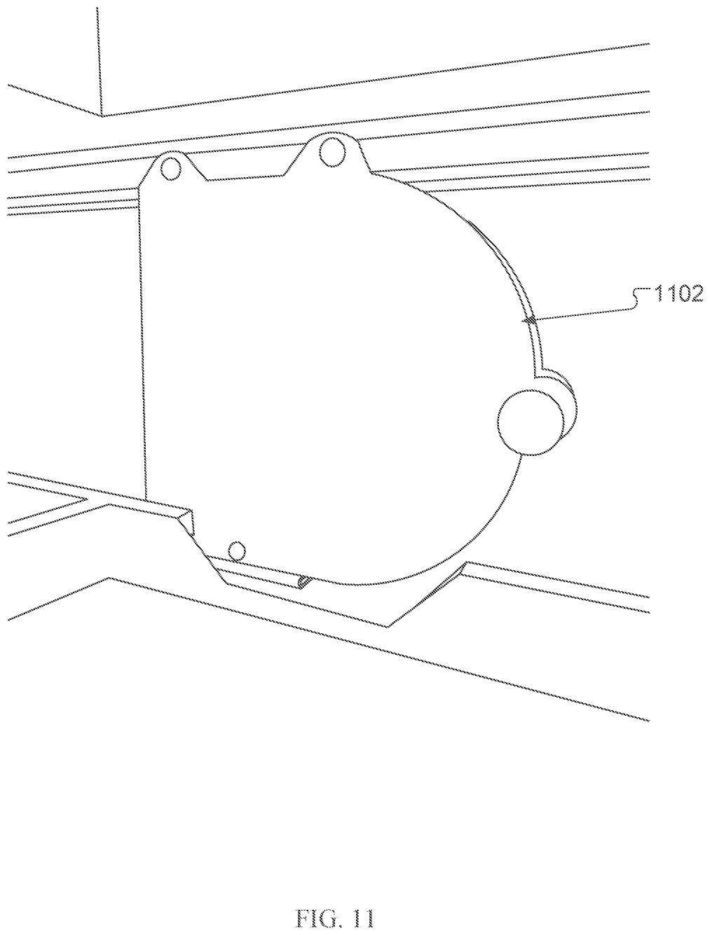

FIG. 9 illustrates an opening 902 at a left side wall of the housing 102 of the pipe threading system 100, according to an embodiment. FIG. 10 illustrates an opening 1002 at a left side wall of the housing 102 of the pipe threading system 100, according to an embodiment. As discussed above, the housing 102 may include openings, such as openings 902 and/or 1002 to receive an end of the pipe for threading. In one embodiment, the pipe may end from the opening 902 at the left side of the housing 102 to the opening 1002 at the right side of the housing 102 in FIG. 1. In one embodiment, the doors may be attached to the openings 902 and/or 1002 so that the openings 902 and/or 1002 may be covered.

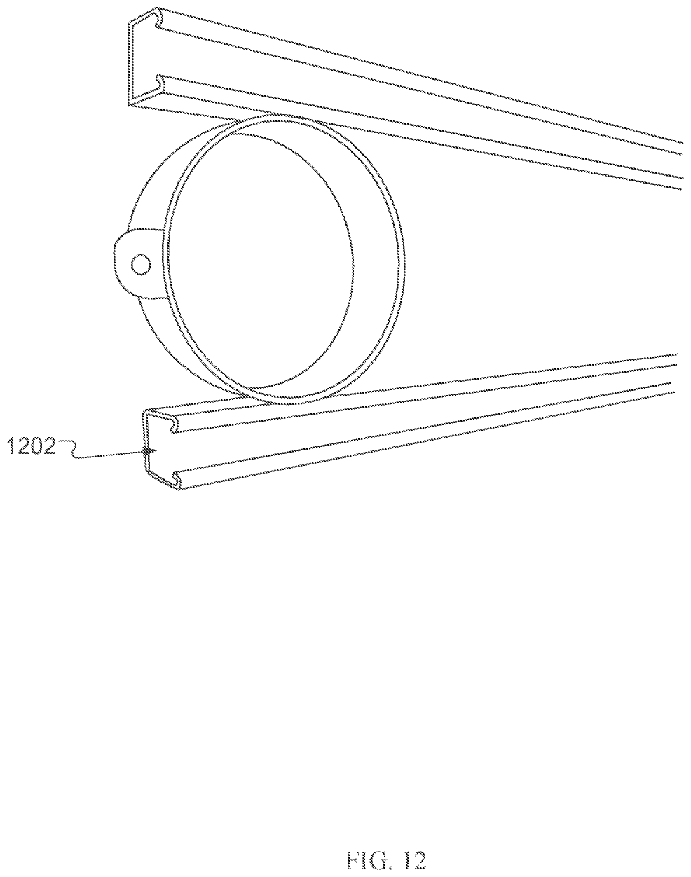

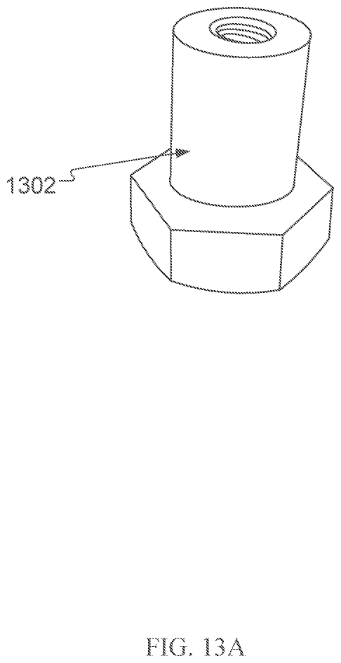

FIG. 11 illustrates a door 1102 that may be configured to cover the opening or be opened to allow objects to be received through the openings 902 and/or 1002, according to an embodiment. In one embodiment, the door 1102 may be attached to the housing 102 in FIG. 1 with hinges. In another embodiment, the door 1102 may slide along rails to slide open and closed. In another embodiment, the door 1102 may be fastened and unfastened to the housing 102. FIG. 12 illustrates slide rails 1202 attached to the housing 102 in FIG. 1, according to an embodiment. In one embodiment, the slide rails 1202 may be located approximate or near the openings 902 and/or 1002. In one example, the slide rails 1202 may be configured for the door 1102 in FIG. 11 to slide along. In another example, the slide rails may be configured to receive a shelf 116 in FIG. 1 or other objects.

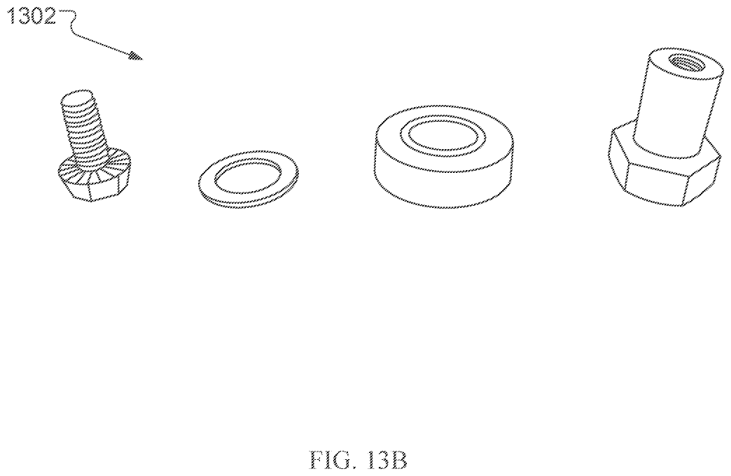

FIG. 13A illustrates a sliding door bearing wheel shaft 1302, according to an embodiment. The sliding door bearing wheel shaft 1302 may be configured for the folding or sliding door of the housing 102 to slide along to open and close when the user opens the door to access the cavity 112 and close when the pipe threading system 100 is not in use or is being transported. FIG. 13B illustrates a disassembled view of the sliding door bearing wheel shaft 1302 in FIG. 13A, according to an embodiment.

The above description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

It is to be understood that the above description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The disclosure above encompasses multiple distinct embodiments with independent utility. While these embodiments have been disclosed in a particular form, the specific embodiments disclosed and illustrated above are not to be considered in a limiting sense as numerous variations are possible. The subject matter of the embodiments includes the novel and non-obvious combinations and sub-combinations of the various elements, features, functions and/or properties disclosed above and inherent to those skilled in the art pertaining to such embodiments. Where the disclosure or subsequently filed claims recite “a” element, “a first” element, or any such equivalent term, the disclosure or claims is to be understood to incorporate one or more such elements, neither requiring nor excluding two or more such elements.

Applicant(s) reserves the right to submit claims directed to combinations and sub-combinations of the disclosed embodiments that are believed to be novel and non-obvious. Embodiments embodied in other combinations and sub-combinations of features, functions, elements and/or properties may be claimed through amendment of those claims or presentation of new claims in the present application or in a related application. Such amended or new claims, whether they are directed to the same embodiment or a different embodiment and whether they are different, broader, narrower or equal in scope to the original claims, are to be considered within the subject matter of the embodiments described herein.

1. An apparatus, comprising:
a housing forming a cavity to store a pipe threading machine, an oiler, and an oil catching system, wherein the housing includes a door that is configured to open to provide access to the cavity;
an opening along a side wall of the housing, the opening being configured to receive an end of the pipe;
the pipe threading machine located within the cavity, wherein the pipe threading machine is configured to cut the pipe, ream the pipe, and thread the pipe using one or more attachments;
the oiler configured to apply oil to the pipe and the one or more attachments as the pipe threading machine at least one of cuts the pipe, reams the pipe, or threads the pipe; and
the oil catching system located within the cavity below the oiler and the pipe threading machine, wherein the oil catching system is configured to catch oil dripping or spraying from the pipe threading machine, the oiler, or the pipe.

2. The apparatus of claim 1, wherein the door is configured to slide along a rail positioned within the cavity to secure the cavity of the housing.

3. The apparatus of claim 1, wherein the door is secured with a pull knob and released by disengaging the pull knob.

4. The apparatus of claim 1, wherein the pipe threading matching is aligned with the opening to receive a pipe passing through the opening with the door in an open position.

5. The apparatus of claim 1, further comprising rollers to facilitate movement of the housing along a surface to position the housing near a job site.

6. The apparatus of claim 1, further comprising brackets securing to an exterior to the housing and configured to facilitate lifting of the housing.

7. The apparatus of claim 1, wherein oil catching system comprises:
an oil splash shield positioned relative to the pipe threading machine to catch oil from the pipe threading machine during processing of a pipe; and
a catch tray having a funneled geometry to receive oil from at least one of the oiler, the pipe threading machine, or the oil splash shield and collect the received oil.

8. The apparatus of claim 1, further comprising a ground fault indicator power plug mounted in the housing to provide a power receipt location on an exterior of the housing and a power distribution location on an interior of the housing.

9. A system comprising:
a housing forming an interior to store a pipe threading machine, wherein the housing comprises:
a bracket positioned on an exterior of the housing to facilitate lifting of the housing to position the housing proximate a job site;
a roller positioned on the exterior of the housing to facilitate moving of the housing along a surface proximate the job site;
a hinged door to provide access to the pipe threading machine by an operator; and
a sliding door to open and close at an opening in the housing to facilitate insertion of a pipe into the interior of the housing, wherein the sliding door is aligned with the pipe threading machine such that a pipe may extend through the opening and into the interior of the housing to engage the pipe threading machine while the pipe is positioned in the opening.

10. The system of claim 9, wherein the roller is lockable to prevent movement of the housing along the surface to secure the housing.

11. The system of claim 9, wherein the hinged door is configured to fold up to a vertical position to allow the access to the interior of the housing.

12. The system of claim 9, wherein the hinged door is configured to lock the hinged door in a closed position to hinder access to the interior of the housing to reduce theft and damage.

13. The system of claim 9, wherein the sliding door comprises a pull knob to secure the sliding door to close the opening.

14. The system of claim 9, further comprising an oil catch to collect oil within the housing and contain the oil for removal from the housing.

15. The system of claim 9, further comprising a shelf positioned on the interior of the housing, the shelf having a geometry that is notched to allow for operation of the pipe threading machine.

16. A method comprising:
forming a housing having a first opening formed in a first side of the housing and a second opening formed in a second side of the housing orthogonal to the first side;
coupling a hinged door to the housing to correspond to the first opening formed in the housing to provide access to an interior of the housing in an open position and reduce access to the interior of the housing in a closed position;
coupling a sliding door to be within the interior of the housing and to correspond with the second opening formed in the housing, wherein the sliding door is configured to provide access to the interior of the housing, through the second opening, in an open position and reduce access to the interior of the housing in a closed position;
disposing a pipe threading machine within the interior of the housing to be accessible through the first opening and the second opening, wherein the pipe threading machine is at least partially aligned with the second opening to receive a pipe through the second opening in the housing.

17. The method of claim 16, further comprising disposing an oil catch system proximate the pipe threading machine to catch oil in the proximity of the pipe threading machine.

18. The method of claim 16, further comprising securing rails within the interior of the housing to receive the sliding door and facilitate translation of the sliding door to and from the second opening.

19. The method of claim 16, further comprising disposing an oiler to apply oil to the pipe within the housing.

20. The method of claim 16, wherein the coupling of the hinged door to the housing comprises disposing a hinge and the top of the hinged door to couple the door to the housing, the hinge configured to rotate to allow the door to rotate upward into the open position.
